(19) United States
(12) Patent Application Publication
(10) Pub. No.: US 2007/0083463 A1
(43) Pub. Date: Apr. 12, 2007

(54) FRAUD ALERT SWITCH

(76) Inventor: Harold H. Kraft, Arlington, VA (US)

Correspondence Address: PROSKAUER ROSE LLP, 1001 PENNSYLVANIA AVE, N.W.,, SUITE 400 SOUTH, WASHINGTON, DC, 20004, US

(21) Appl. No.: 11/533,755

(22) Filed: Sep. 20, 2006

Related U.S. Application Data
(60) Provisional application No. 60/596,399, filed on Sep. 20, 2005.
(60) Provisional application No. 60/597,514, filed on Dec. 6, 2005.
(60) Provisional application No. 60/596,394, filed on Sep. 20, 2005.

(51) Int. Cl. G06Q 40/00

(52) U.S. Cl. 705/38

(57) ABSTRACT

A credit freeze on-off switch implemented through, for example a web page control, is provided for consumers to quickly and inexpensively freeze and unfreeze their credit files with the major credit bureaus. This helps prevent credit fraud before it happens.

### CROSS REFERENCE TO RELATED APPLICATIONS

The present application claims the benefit of priority of U.S. provisional applications 60/596,394, filed Sep. 20, 2005 and 60/597,514, filed Dec. 6, 2005, each of which is hereby incorporated by reference in its entirety.

### BACKGROUND

Many states provide a legal right for consumers to put a “security freeze” on their credit files with any of the credit bureaus. A security freeze means the consumer file cannot be shared with potential creditors. This can help prevent identity theft because most businesses will not open credit accounts without checking a consumer's credit history beforehand. If a consumer's credit files are frozen, even someone who has the consumer's name and even Social Security number is unlikely to find it possible to obtain credit in the consumer's name.

A security freeze is often free if consumers who can provide proof they are victims of identify theft. However, a fee can be paid to place a freeze, which is a nominal processing fee, generally. The fee may also be guaranteed by statute.

To place a freeze, currently, consumers must write to each of the three credit bureaus to identify themselves, provide a copy of a police report or other proof if appropriate, or provide a payment. While this is a useful device, it is generally used in special circumstances.

### SUMMARY

The inventor has recognized that a credit freeze may be useful to allow consumers to proactively safeguard against identity theft. If a consumer could quickly and conveniently, with reasonable cost, switch a credit freeze on and off at will, the consumer could leave their credit in the frozen state except when the consumer specifically wishes to allow a creditor to obtain access, such as when opening a credit card account or buying a new car. Such a device is provided through a web-based service, which may be provided by a third party, for example.

The consumer registers with the service providing authenticating information to allow the service provider to create and store a profile. Each time the consumer wishes to change the consumer's credit status, the user logs into the service provider site and uses a control, for example, a web control, to change it. The change is then submitted to the service. The service provider stores the current status of the client consumer and only needs to generate a change request and send to the credit bureaus if the current status is different from the previous. In one embodiment the consumer is only charged when s/he changes her status and triggers the transmission of a change request to the credit bureaus.

The service provider automatically accumulates changes made by various client consumers and queues them for transmission to the credit bureaus. Periodically (e.g., three times a day), the service provider sends batches of requests to the credit bureaus and receives confirmation files from the credit bureaus. Confirmation letters, for example sent by email or mail, are then generated automatically and sent to consumers. Alternatively or in addition, the confirmed status can be shown in a dashboard interface when the consumer logs into the service provider's site.

In an embodiment, hard and soft status changes can be submitted. With a soft change, the change request is submitted as described. With a hard change, a request is made to place the consumer's account in the chosen state irrespective of the current status. Thus, if a consumer is in doubt about the consumer's credit status or fears that there may be come confusion either on the part of the service provider or the credit bureaus, the consumer can have a desired status concretely asserted. In such a case, the request for a current status is always made to the credit bureaus.

In another embodiment, the consumer authenticates him/herself and transmits requests for change of status through a portable appliance such as cell phone by generating a special SMS message or by automatic phone key menu system. Yet another alternative is to provide a mobile web page for hand held web enabled devices such as cell phones and wireless personal digital assistants (PDAs).

In yet another embodiment, an upgraded service is provided by the credit bureaus to provide consumers with an activity report. The latter could be provided in the confirmation files sent by creditors when a status change is sent, or generated as part of a separate service. For example, it might be useful for the consumer to know if his or her credit report was requested while the consumer had it frozen. In another embodiment, the credit bureaus, possibly as part of an enhanced service, generate alerts when credit reports are requested. This could be instantly delivered by email or other rapid service such as SMS. Details could be viewed on the service provider's web site, assuming appropriate data are sent from the credit bureaus to the service provider, who can add this to the consumer's profile.

According to an embodiment, the invention is a method of permitting consumers to change their current credit freeze status, comprising the steps of: providing consumer accessible digital control that allows a consumer to enter and transmit personal information to a service provider located at a provider location, receiving personal information from a consumer, receiving authorization information including preference data indicating whether the credit files of a consumer associated with the personal data should be frozen, thereby enabling a status that prevents credit reports associated with the consumer from being provided by at least one credit bureau which otherwise provides credit reports to creditors requesting them, storing the personal information at the provider location, making available, to at least one credit bureau, request data derived from the preference information, such that the credit bureau, in response to the request data, selectively freezes or unfreezes the consumer's credit files. In a refinement the method may be such that the step of making available includes transmitting a batch file from the provider location to a location of the at least one credit bureau. In a further refinement, the method may be such that the step of providing includes generating a computer form. In a further refinement, the method may be such that the step of providing includes generating web form object.

In a further refinement, the method may be such that the at least one credit bureau includes at least two credit bureaus. In a further refinement, the method may include receiving at the provider location a confirmation of a change of the status.

According to another embodiment, the invention is a method of permitting consumers to change their current credit freeze status, comprising the steps of: providing consumer accessible digital control that allows a consumer to enter and transmit personal information to a service provider located at a provider location, receiving personal information from a consumer and storing the personal information, receiving a first request from the consumer indicating a desire to freeze a credit file held by at least one credit bureau, in response to the first request, transmitting a request to the at least one at least one credit bureau to freeze the credit file, receiving a first request from the consumer indicating a desire to unfreeze a credit file held by at least one credit bureau, in response to the first request, transmitting a request to the at least one at least one credit bureau to unfreeze the credit file. In a further refinement, the method includes receiving a confirmation of a current status indicating whether the consumer credit file is frozen or unfrozen in response to one of at least one of the steps of transmitting. In a further refinement, the method may be such that each of the steps of transmitting includes generating a batch file. In a further refinement, the method may be such that the step of transmitting includes verifying information in the stored personal information corresponding to the first and second requests.

The inventions will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 illustrates a network or Internet architecture for implementing various features of the present inventive embodiments.

FIG. 2 illustrates communication among various entities and processes for illustrating an embodiment of the invention.

FIG. 3 is a flow chart for illustrating a basic embodiment of the invention.

FIG. 4 illustrates communication among various entities and processes for illustrating another embodiment of the invention

### DETAILED DESCRIPTION OF THE DRAWINGS

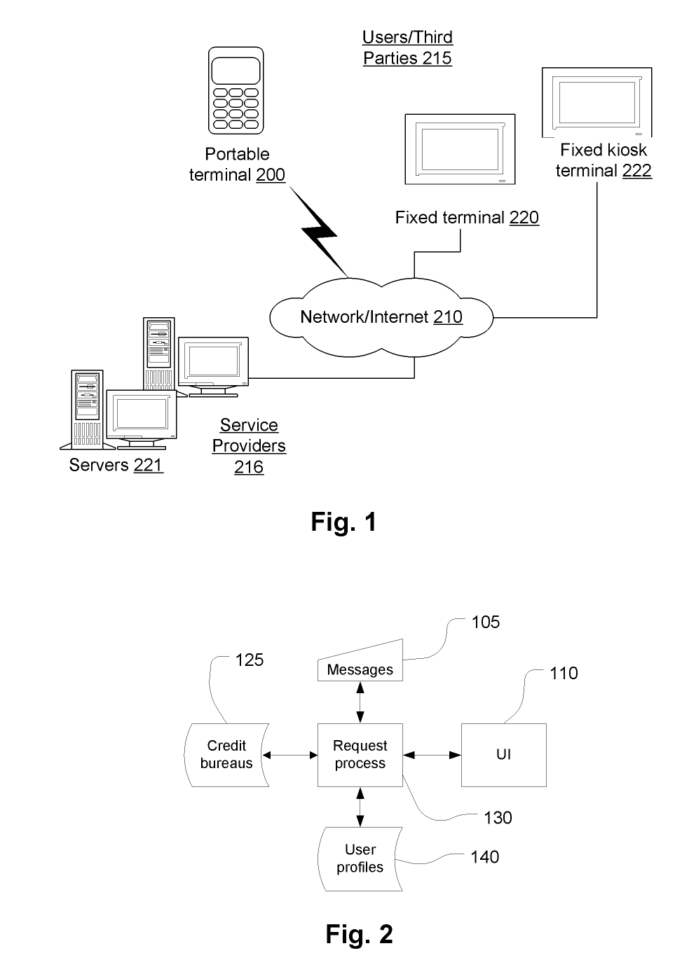

FIG. 1 illustrates a network or Internetwork architecture for implementing various features of the present inventive embodiments. The inventive embodiments concern various data stored in databases and user interfaces such as browser sessions generated on client terminals. A user 215 may request information from one or more service providers 216 through a wireless 200, or fixed 220, 222 terminal. The request may be entered in a form, for example an html form generated by a server 221 and transmitted to the terminal 200, 220, 222 via a network, internetwork, and/or the Internet 210. Data submitted by the user (or interested third party, assuming the subject of the data is said user) 215 may be transmitted from the terminal 200, 220, 222 via a network, internetwork, and/or the Internet 210 to the server 221 (which may be the same or a different server or servers) and used to generate a query or a permanent or semi-permanent user-profile. Queries may be generated on one server 221 and transmitted, via network, internetwork, and/or the Internet 210, to another server 221 and in response data obtained as a result of the query and also transmitted, via a network, internetwork, and/or the Internet 210, to the user or third party 215 at a corresponding terminal 200, 220, 222 or some other location, for example a permanent or semi-permanent data store for future access (not shown separately but structurally the same as servers 221). The network, internetwork, and/or the Internet 210 may include further servers, routers, switches and other hardware according to known principles, engineering requirements, and designer choices.

FIG. 2 illustrates the instrumentalities that enable interaction between a user and the credit bureaus to provide, effectively, an on-off switch for credit freezes. First business relationships between the credit bureaus and the service provider are set up where a service provider agrees to provide credit freeze updates in a particular format for a small transaction fee paid to the credit bureaus. This may or may not be required depending on the legal and business environment at the time of implementation. For example, the credit bureaus could be required by law to accept change notifications through authorized third parties.

A user interface 110 allows users to authenticate themselves and provides controls to allow users to change their credit status. The user interface may be generated by one or more browser sessions. Information obtained from the user can be stored in a profile 140, which may be a database storing many profiles corresponding to many customers of the service provider. The profile may store current and changed freeze status information for each customer and may also store a history of such requests. A request process 130 periodically queues and batch-transmits requests from many customers to the various credit bureaus 125. Confirmations and other data may be received from the credit bureaus 125 after they store the change of status of the various requesters. Then, the request process 130 may, in turn store the confirmation information in the user's profiles and transmit messages 105 to users providing confirmation or other information. The latter may be done by wireless transmissions or email for example.

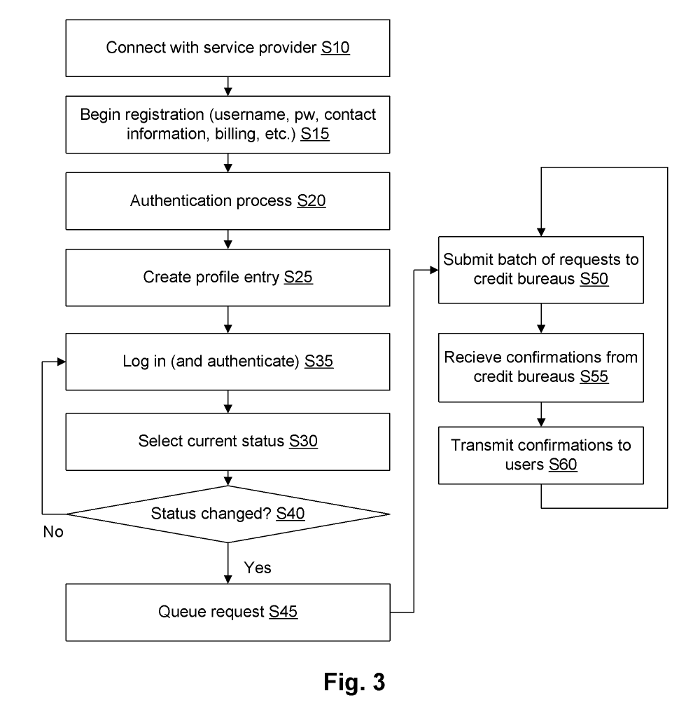

FIG. 3 illustrates a process for implementing the behavior discussed with reference to FIG. 2. In the first steps S10, S15, and S20, a user exchanges information with a service provider. The service provider may be a stand-alone business or it may be an organization in which the credit bureaus have an interest, or any other kind of entity. The service provider may implement the exchange of step S10 by providing a web site that generates a web form page and instructions allowing a user to enter personal identifying and authentication information as well as payment information. Such a form may also provide instructions and background information on the services provided and allow the user to select certain services to opt into.

Once the user is registered, at step S25 the user's personal information including credit billing authorization, is stored in a profile database maintained by the service provider. The profile may also store a history of information about the user, such as the user's current and past status changes, access requests to the user's credit report obtained from the credit bureaus, etc. In a first session, the user may be automatically logged in after payment confirmation or in subsequent sessions, the user may log in in step S35. The user, then, selects his current status at step S30. The latter may be by selecting a control on a web page, such as a radio button. The status selections may include the options: Freeze and Unfreeze. The current status may be compared with one stored in the user's profile at step S40. If the current status is changed from the previous status (e.g., previously frozen and the request was to unfreeze or previously unfrozen and the request was to freeze), a request is stored for later transmission in step S45. If the request results in no change in status, at step S40, nothing happens until the user logs in again and the process is repeated beginning at step S35.

Periodically, in a process that occurs outside the flow of the first column of FIG. 3, requests that have been stored for transmission to the credit bureaus are formatted into a batch file, for example an XML file, which can be easily parsed and processed by the credit bureaus computers. This information is then transmitted to the various credit bureaus in step S50. Reciprocal data such as confirmation information, historical information about the users, and other information such as payment transaction information relating to the service provider and credit bureau business relationships may be transmitted from the credit bureaus to the service provider in step S55. The credit bureaus may transmit information about instances of requests made for credit reports and possible refusals by the credit bureaus depending on the status.

The service provider may, in response to receipt of confirmation information in step S55, transmit a further confirmation or other information to its customers. For example, in step S60, an immediate message may be transmitted via SMS or email indicating and confirming that the user's credit report is frozen and that the credit bureaus have confirmed that status. Separate messages may be generated, preferably automatically, as each credit bureqau confirms the status. This helps to ensure against mistakes in the communication system of FIGS. 2 and 3. In addition to a simple confirmation, may include event that have occurred since a last communication with the credit bureaus. The confirmation and historical data may be stored in the user's profile to allow the user to check the status.

The above are not the only embodiments contemplated by the inventor. Other features and variations may be included as discussed below. For example, when the user fails to change his or her status for a period of time, periodic assertions for a current status may be automatically generated to obtain a confirmation of status from the credit bureaus. This would be like a dummy request sent in step S50.

In another embodiment, hard and soft status changes can be submitted. With a soft change, the change request is submitted as described. With a hard change, a request is made to place the consumer's account in the chosen state irrespective of the current status. Thus, if a consumer is in doubt about the consumer's credit status or fears that there may be come confusion either on the part of the service provider or the credit bureaus, the consumer can have a desired status concretely asserted. In such a case, the request for a current status is always made to the credit bureaus.

In another embodiment, the consumer authenticates him/herself and transmits requests for change of status through a portable appliance such as cell phone by generating a special SMS message or by automatic phone key menu system. Yet another alternative is to provide a mobile web page for hand held web enabled devices such as cell phones and wireless personal digital assistants (PDAs).

In yet another embodiment, an upgraded service is provided by the credit bureaus to provide consumers with an activity report. The latter could be provided in the confirmation files sent by creditors when a status change is sent, or generated as part of a separate service. For example, it might be useful for the consumer to know if his or her credit report was requested while the consumer had it frozen. In another embodiment, the credit bureaus, possibly as part of an enhanced service, generate alerts when credit reports are requested. This could be instantly delivered by email or other rapid service such as SMS. Details could be viewed on the service provider's web site, assuming appropriate data are sent from the credit bureaus to the service provider, who can add this to the consumer's profile.

The foregoing means by which the on-off freeze switch is accomplished can take many forms. For example, all data, including freeze status information, may be stored by the service provider. The credit bureaus may simply selectively or always query the user's data to determine if the current status of a user permits the transmission of a credit report every time a credit report is requested. This would add a transactional layer, but would not require the credit bureaus to update their own information automatically.

A related embodiment provides benefits in the context of credit authorization, password key-rings, virtual wallets, and similar concepts. Secure authentication services exist, but the average person is forced to have multiple different “identities” (authentication systems) for the different services s/he uses. For example, an employer may require its employees to log in using an employee number and a bank may require a mag stripe and a personal identification number. To ameliorate the confusion and difficulty, there has been a move to help individual create a single sign-in infrastructure or virtual wallet. Microsoft's Passport is an example. The goal is a single mechanism for authenticating and authorizing transactions that a user can connect to and use without having to manage many different identities. Such services may also store, safeguard, and automatically convey to authorized 3^{rd} parties, personal information required to complete transactions.

To explain the approach, consider a hypothetical example where an identify thief fraudulently transfers money from a credit card account while the victim is at home watching television. If the individual only knew about the transaction, he could notify the creditors and stop this fraud in its tracks. Unfortunately, even though the individual is available through many communications vehicles, including the Internet, cell phone, computer, telephone, etc., these communications vehicles are of little use in this situation. Identifying a fraudulent transaction out of the many a given creditor has to handle, or alternatively, contacting every credit card holder at his home number to verify that a transaction is real, is difficult. What would be more suitable, in this case, is a way for the victim to inform the bank, and anyone else who might unwittingly support a fraudulent transaction, that the individual is at home, watching television and not taking out a mortgage three states away from the victim's home address. The next embodiment takes an analogous approach, but according to short time scales as well as very long time scales.

In the following embodiments, information is provided by individuals or entities whose authorization and/or identity may be stolen or misused the ability to interrupt or limit the mechanisms by which authorization and authentication may be provided by the various systems. In a centralized system such as a virtual wallet, the same things that make it easy to perform a transaction also make it easier to stop any transactions from happening.

In an embodiment of the invention, a service allows a user to enter rules for preventing the use of the user's credit information, wallet information, or other kinds of information needed for transactions where the user's identity is concerned. For example, the rules may prohibit or provide for a higher standard of authentication for certain kinds of transactions defined by such information as time of day, type of transaction such as a loan, class of vendor or service provider, monetary amount per transaction, or per unit of time (e.g., per week), or even after designated events, such as marriage, divorce, death, address change, etc.

In the above context, a service provider allows users to create profiles that store the rules. The user is provided with selections for rules through a user interface. Preferably, the service provider has selections for the criteria that make up the rules such as criteria relating to selected events or conditions. Examples are listed below. Such rule-defining mechanisms are well-known in software, for example, rule interfaces that allow email clients to determine how to handle incoming emails based on who is sending the email. Preferably the system allows the user to create conjunctive and/or disjunctive lists of conditions. Generic rule profiles may also be predefined and selected by a user according to a class the user believes best fits him. Preferably, where such are offered, the user is provided a way to customize the rules.

When a transaction is pending approval, the service provider receives a request for approval of the transaction from a creditor, a credit bureau, or transaction originator, such as a vendor. The service provider may be subsumed within a credit bureau or credit reporting agency. The rule base is consulted when the request is received and an indication of some characteristic of the transaction is sent such an indication that it should be approved or should not be approved. Alternatively, the indication could be such that a higher level of authentication should be required before approval.

As for how the conditions that the rules depend on, these may be provided by the user based on various information channels. One choice is for the user to update his current status. For example, the user, or his legal proxy, could log into his service provider profile and indicate an upcoming life-event, such as marriage, a divorce, change of address, a vacation, an illness in which the user will be in the hospital, a jail sentence, quitting work and going to school, an injury, a civil suit, a bankruptcy, and so on. These events could be delimited by dates that are entered by the user. Information could enter the service provider's system automatically through other channels as well. For example, the service provider system could accrue a total monetary amount of transactions over a period of time and the rule information could base approval on that quantity and a condition, such as an upper threshold per week or month. Also the service provider could access information sources, both public and private, to obtain information about the user to obtain the information needed for the conditions associated with the rules.

In an embodiment, the user may log into the wallet service provider's web site, sign on using an authentication system, and select an interval of time (lockdown) during which no transactions are to be permitted. The service may provide a way to reverse this setting in the middle of such an interval through much more secure processes than are ordinarily used. The service may charge for each time a lockdown is reversed, thereby avoiding the problem of having to deal with too many reversals which might make the system uneconomical. Other kinds of rules may be provided such as when certain kinds of events are detected by the wallet service provider, the lockdown should be implemented. Also, the rules may allow the wallet owner to impose his own credit limits for specified periods of time. For example, it is common for a credit card holder to have far more credit on his card than he is likely to use in a given year. The user could impose a limit, which he himself can increase, but only by going through a rare strong authentication procedure. Again the wallet service provider may charge a strong authentication fee.

The above concept may be applied to the use of personal information as well. A user may be provided the ability to prevent the transfer of his shipping information to anyone during a specified period of time. (Except that the exceptional reversal can be implemented for unforeseen circumstances) For example, the user could create a rule that shuts down all exportation of his shipping information except during a two-hour period in the evening when he might be shopping online.

Another way to implement a similar benefit is to supply a trusted central system with certain rules or guidelines by which they may augment their own fraud-detection systems. For example, there are insurance companies and credit companies and banks who employ mathematical models of fraudulent behavior to try to detect a fraud before an injury occurs. But these are based on generalized models of behavior. What if such insurance companies and credit companies and banks could ask each individual about his or her behavior and customize the individual's fraud model to suit? Obviously, the recipients of such customization information need to safeguard against fraud in the process of taking in the information, but since this is relatively infrequent, stronger authentication procedures may be followed such as calling the user back on his previously-stored home phone number.

According to the above model, the rules would not have to be so cut and dried. It would be possible to add fuzzy information to the wallet-holder's personal information such as the user “rarely goes out of state,” “will be out of the country in February 2006,” “never buys online,” and such trends. The wallet service can provide templates of such rules for the user to consider.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A method of permitting consumers to change their current credit freeze status, comprising the steps of:
providing consumer accessible digital control that allows a consumer to enter and transmit personal information to a service provider located at a provider location;
receiving personal information from a consumer;
receiving authorization information including preference data indicating whether the credit files of a consumer associated with said personal data should be frozen, thereby enabling a status that prevents credit reports associated with said consumer from being provided by at least one credit bureau which otherwise provides credit reports to creditors requesting them;
storing said personal information at said provider location;
making available, to at least one credit bureau, request data derived from said preference information, such that said credit bureau, in response to said request data, selectively freezes or unfreezes said consumer's credit files.

2. A method as in claim 1, wherein said step of making available includes transmitting a batch file from said provider location to a location of said at least one credit bureau.

3. A method as in claim 1, wherein said step of providing includes generating a computer form.

4. A method as in claim 1, wherein said step of providing includes generating web form object.

5. A method as in claim 1, wherein said at least one credit bureau includes at least two credit bureaus.

6. A method as in claim 1, further comprising receiving at said provider location a confirmation of a change of said status.

7. A method of permitting consumers to change their current credit freeze status, comprising the steps of:
providing consumer accessible digital control that allows a consumer to enter and transmit personal information to a service provider located at a provider location;
receiving personal information from a consumer and storing said personal information;
receiving a first request from said consumer indicating a desire to freeze a credit file held by at least one credit bureau;
in response to said first request, transmitting a request to said at least one at least one credit bureau to freeze said credit file;
receiving a first request from said consumer indicating a desire to unfreeze a credit file held by at least one credit bureau;
in response to said first request, transmitting a request to said at least one at least one credit bureau to unfreeze said credit file.

8. A method as in claim 6, further comprising receiving a confirmation of a current status indicating whether said consumer credit file is frozen or unfrozen in response to one of at least one of said steps of transmitting.

9. A method as in claim 6, wherein each of said steps of transmitting includes generating a batch file.

10. A method as in claim 6, wherein said step of transmitting includes verifying information in said stored personal information corresponding to said first and second requests.
